(19) United States
(12) Patent Application Publication
(10) Pub. No.: US 2005/0211054 A1
(43) Pub. Date: Sep. 29, 2005

(54) Snap away stringed musical instrument pick

(76) Inventor: Neil Rapaport, Chatsworth, CA (US)

Correspondence Address: CHRISTIE, PARKER & HALE, LLP, PO BOX 7068, PASADENA, CA, 91109-7068, US

(21) Appl. No.: 10/811,091

(22) Filed: Mar. 26, 2004

(51) Int. Cl. A63F 9/00; A63B 71/00; G10D 3/16

(52) U.S. Cl. 84/322

(57) ABSTRACT

Snap away musical instrument picks. A sheet of material is provided that has a plurality of musical instrument picks formed therein by a cut line around the perimeter of the picks except for uncut web areas around each pick. A pick can be detached from the card body by severing the web to remove a pick when desired. The sheet of material can be sized to be carried in a purse or wallet or hung on a microphone stand and the like for easy access.

### SUMMARY OF THE INVENTION

The invention is in the field of plectrums, or “picks”, for stringed musical instruments, and more particularly a die-cut, snap away pick for guitars and other stringed musical instruments that can be easily detached from a card, sheet, strip and the like.

Many stringed instruments such as guitars, mandolins, basses are played with picks, which consist of small generally flat pieces of material that are usually (but not always) flexible. Picks come in many sizes and are made of many kinds of materials including plastics (e.g. PVC, acetal polyoxymethylene (POM) resins (i.e. Delrin®), Nylon, etc), shell, metal, stone, paper, composite materials and other materials. Picks are manufactured to have a variety of thicknesses and stiffnesses, depending on a user's preferences. Picks are often shaped to have one or more rounded points, and can have a generally ogive shape at one or more ends. Picks come in numerous colors and can have graphics appearing thereon. Indeed, picks are collected by musicians and non-musicians alike.

Picks are often displayed at music stores in bulk in plastic bags, in open containers, displayed on paper displays, and the like.

Although picks can last a long time, they are frequently lost or misplaced, and users may wish to use different picks for different songs, instruments and conditions. Lacking a proper pick, a musician can improvise and use another object, such as a coin, as a pick if required. It would be useful for musicians to have a convenient way to carry extra picks so that they are available anytime and any place.

It would also be useful to provide a readily accessible supply of picks to musicians during performances that can easily be taken when needed, yet will not be misplaced or lost.

### BRIEF DESCRIPTION OF THE DRAWINGS

Further advantages of the invention will become apparent upon a reading of the following detailed description taken in conjunction with the accompanying drawings.

FIG. 1 is a top plan view of a first exemplary embodiment of a wallet-sized card of detachable picks.

FIG. 2 is a top plan view of the wallet-sized card of FIG. 1 after one pick is removed and the removed pick.

FIG. 3 is a top plan view of a second exemplary embodiment of a wallet-sized card of detachable picks.

FIG. 4 is a top plan view of a third exemplary embodiment of a wallet-sized card of detachable picks.

FIG. 5 is a top plan view of a fourth exemplary embodiment of a wallet-sized card of detachable picks.

FIG. 6 is a top plan view of an exemplary embodiment of detachable picks on a larger sheet.

FIG. 7 is a top plan view of an exemplary embodiment of detachable picks on a strip of picks that can be supported on a microphone stand and the like.

FIG. 8 is a top plan view of another exemplary embodiment of a wallet-sized card of detachable picks bearing graphical images.

### DETAILED DESCRIPTION OF THE INVENTION

Referring to FIG. 1, there is shown a top plan view of a first exemplary embodiment of a wallet-sized card 10 of detachable picks. In this card 10, three detachable picks 12A, 12B and 12C are attached to the card body 14 by webs 16 separating cut line sections 18A, 18B and 18C. The card 10 can be made of material such as plastic (e.g., PVC, acetal polyoxymethylene (POM) resins (i.e. Delrin®), polycarbonate, Nylon, etc.), laminated paper, composite materials, etc., and the picks can be conveniently die-cut from the card leaving the webs intact so that the picks remain integral with the card until the webs are broken or cut (e.g. by pushing on the pick or slicing the webs with a blade.) The width and size of the webs can be varied depending on how much force is desired to remove a pick from the card. Although three webs 16 are shown bridging between each pick and the card body 10, a lesser or greater number of webs can be used depending on how secure the picks need to be carried on the card. Depending on the materials used, the card thickness (and thus pick thickness) can be varied to control the stiffness of the pick. Using PVC sheet material, good results have been achieved with 0.51 mm thickness material (0.02″ or 20 mil), 0.76 mm thickness material (0.03″ or 30 mil), 1.02 mm thickness material (0.04″ or 40 mil), and 1.27 mm thickness material (0.05″ or 50 mil). Other thicknesses can be used, and these thicknesses apply to all of the embodiments disclosed herein.

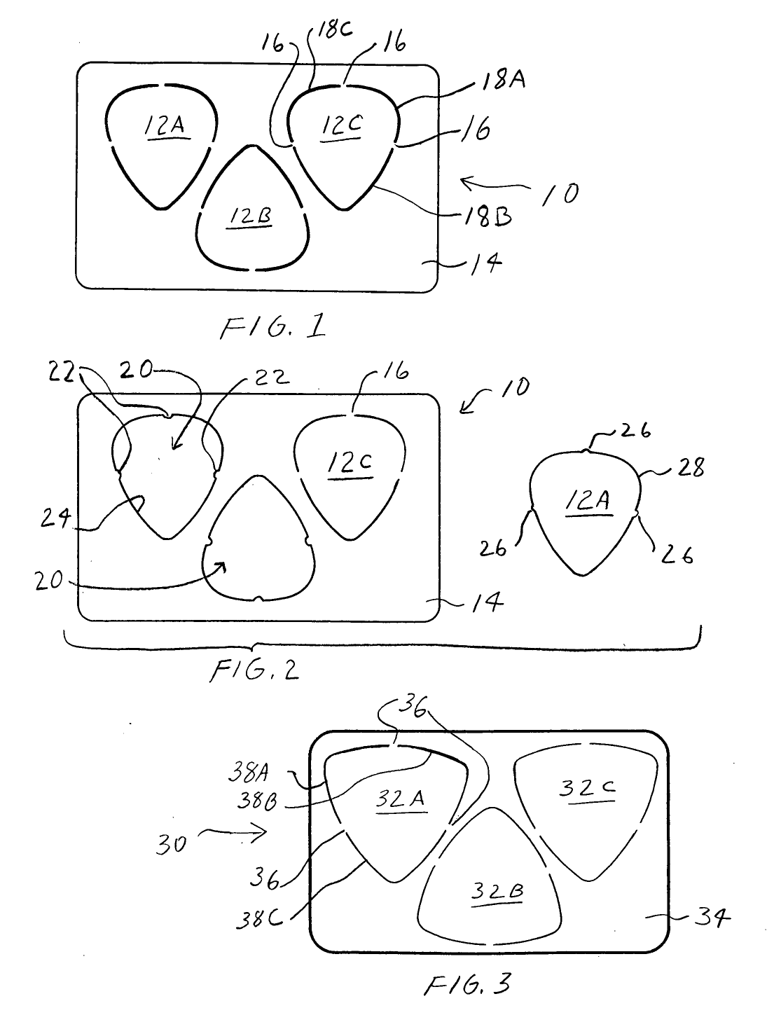

FIG. 2 is a top plan view showing the wallet-sized card 10 of FIG. 1 with two picks removed and one of the removed picks 12A. As can be seen, after picks are removed from the card, holes 20 are left with remnants of webs 22 shown on the perimeter 24 of the cut line. Snapped off pick 12A is shown, with remnants of webs 26 shown around its perimeter 28.

FIG. 3 is a top plan view of a second exemplary embodiment of a wallet-sized card 30 of detachable picks. The picks 32A, 32B and 32C are integral with card body 34 and are connected therewith with webs 36, and are die cut from card with cut lines 38A, 38B and 38C between the webs. The picks 32A, 32B and 32C have a different shape than the picks 12A, 12B and 12C of FIGS. 1 and 2, but in other respect, this embodiment is similar.

FIG. 4 is a top plan view of a third exemplary embodiment of a wallet-sized card 40 of detachable picks, where the picks 42A, 42B, 42C, 42D and 42E are integral with card body 44 but each pick is connected to the card by two webs 46 and has cut lines 48A and 48B between the webs 46. While a total of five picks 42A, 42B, 42C, 42D and 42E are shown, a greater or lesser number of picks can be arranged on the card.

FIG. 5 is a top plan view of a fourth exemplary embodiment of a wallet-sized card 50 of detachable picks, where the picks 52A, 52B, 52C, 52D and 52E are integral with card body 54 but each pick is connected to the card by two webs 56 and has cut lines 58A and 58B between the webs 56. While a total of five picks 52A, 52B, 52C, 52D and 52E are shown, a greater or lesser number of picks can be arranged on the card. In this embodiment, the picks 52A, 52B, 52C, 52D and 52E all have a different size and shape.

With respect to the card bodies of FIGS. 1-5, they can be conveniently sized to be the same or similar to charge cards, credit cards or business cards (e.g. from about 50.8 mm to 54 mm (2″ to 2.125″) by about 85.7 mm to 88.9 mm (3.375″ to 3.5″)) so that it can be conveniently carried in a user's wallet or handbag along with other similar sized cards. Naturally, other sizes can be used.

FIG. 6 is a top plan view of an exemplary embodiment of a large sheet 60 with detachable picks 62 die cut from a sheet of material 64. Each pick is detachably attached to the card body 64 by breakable and cutable webs 66. These large sheets can hung from a display stand by an optional hole 68 formed in the card body 64.

FIG. 7 is a top plan view of an exemplary embodiment of a strip 70 of detachable picks that can be hung from a microphone stand and the like. The strip 70 has a plurality of picks 72A, 72B, 72C and 72D integral with the strip body 74. The picks are attached to the strip body 74 by at least one web 76. The strip 70 will preferably have a hole 78 formed therein for hanging on a microphone stand or other support so that the picks are readily available during musical performance. If desired, instead of a hole, a die cut break away portion that will readily permit a hole to be formed in the strip can be provided in the strip (not shown.) With the single web design, one or more picks 72A, 72B, 72C and 72D can be swung out from the plain of the strip body 74 so that a user can easily grab a pick and twist it to free a pick very easily and quickly.

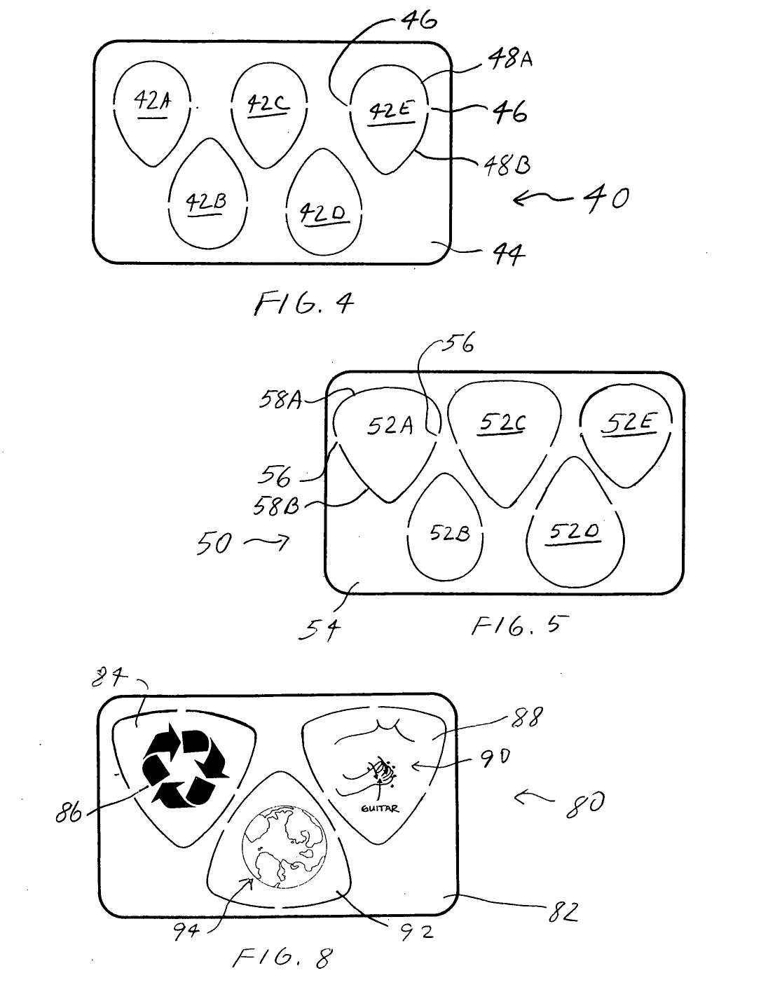

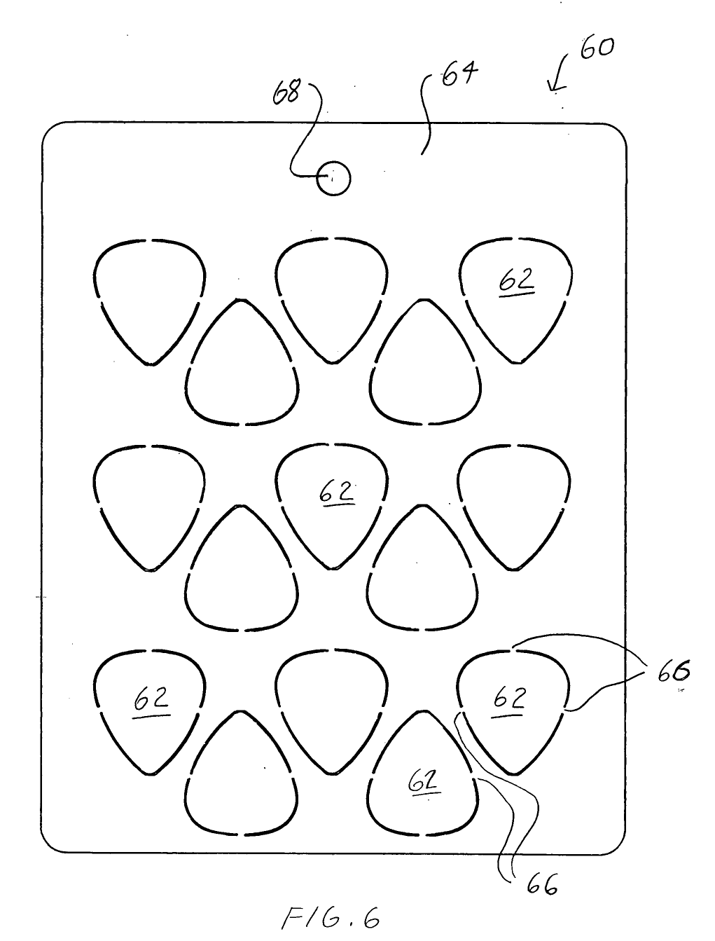

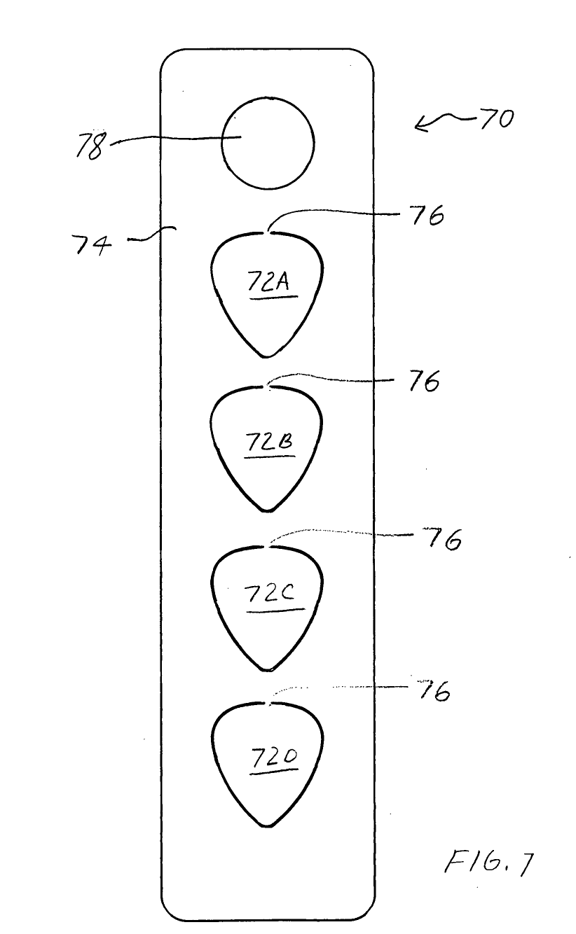

Referring to FIG. 8, there is shown a top plan view of another exemplary embodiment of a wallet-sized card 80 of detachable picks 84, 88 and 92, wherein each pick bears graphical images 90, 86 and 94, respectively. A single card can also be printed with a single image, and each pick can bear part of that entire image. The physical construction of this exemplary embodiment can be similar to that shown in FIG. 3.

Although a preferred embodiment of the present invention has been described, it should not be construed to limit the scope of the appended claims. For example, the present invention may be implemented to include a variety of different pick sizes, shapes, thicknesses and layouts.

In addition, those skilled in the art will understand that various modifications may be made to the described embodiment. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

1. Snap away musical instrument picks, comprising:
a sheet of material with at least one musical instrument pick formed therein by at least one cut line around a portion of the pick, with at least one uncut area around the at least one pick defining a web joining the at least one musical instrument pick to a card body outside of the at least one cut line, wherein the pick can be detached from the card body by severing the webs.

2. The snap away musical instrument pick of claim 1, wherein the sheet of flat material comprises generally rigid plastic sheet material.

3. The snap away musical instrument pick of claim 1, wherein the cut lines are formed by die cutting.

4. The snap away musical instrument pick of claim 1, wherein the sheet of flat material is sized to carry between three and five picks.

5. The snap away musical instrument pick of claim 1, wherein the plurality of picks on a sheet have the same size and shape.

6. The snap away musical instrument pick of claim 1, wherein the plurality of picks on a sheet are different in at least one of size and shape.

7. The snap away musical instrument pick of claim 1, further comprising an aperture for carrying the card body on another structure.

8. The snap away musical instrument pick of claim 7, wherein the aperture is one of preformed on the card body and comprises a break-away section that can be readily removed to expose the aperture when desired by the user.

9. The snap away musical instrument pick of claim 1, wherein each pick is attached to the card body by a single web.

10. The snap away musical instrument pick of claim 1, wherein the card body is elongate and carried a plurality of picks in a single line.

11. The snap away musical instrument pick of claim 1, wherein the sheet of flat material is selected from the group consisting of plastic sheet material, shell, bone, metal and paper.

12. The snap away musical instrument pick of claim 1, wherein the sheet of material is flat.

13. The snap away musical instrument pick of claim 1, wherein the picks bear graphical images.

14. Snap away musical instrument picks, comprising:
a sheet of material with a plurality of musical instrument picks formed therein, with each pick being formed by at least one gap line defining a perimeter of the pick, with at least one uncut web bridging between each pick and a card body outside of the at least one cut line, wherein the pick can be detached from the card body if desired by severing the at least one web.

15. The snap away musical instrument pick of claim 14, wherein the sheet of flat material comprises generally rigid plastic sheet material.

16. The snap away musical instrument pick of claim 14, wherein the at least one gap line is formed by die cutting.

17. The snap away musical instrument pick of claim 14, further comprising an aperture for carrying the card body on another structure.

18. The snap away musical instrument pick of claim 14, wherein each pick is attached to the card body by a single web.

19. The snap away musical instrument pick of claim 14, wherein the card body is elongate and carried a plurality of picks in a single line.

20. The snap away musical instrument pick of claim 14, wherein the sheet of material is flat.
